(19) United States
(12) Patent Application Publication
(10) Pub. No.: US 2004/0200429 A1
(43) Pub. Date: Oct. 14, 2004

(54) Feeding apparatus

(76) Inventor: Daina Hohn, Santa Monica, CA (US)

Correspondence Address: Pillsbury Winthrop LLP, Intellectual Property Group, 725 South Figueroa Street, Suite 2800, Los Angeles, CA, 90017-5406, US

(21) Appl. No.: 10/392,230

(22) Filed: Mar. 19, 2003

(51) Int. Cl. A01K 39/01

(52) U.S. Cl. 119/464

(57) ABSTRACT

An apparatus is provided for feeding birds. The apparatus is configured to resist destruction by birds and to be firmly attached to a perch, branch or cage bar. The apparatus includes a bowl that is threadably engaged to a bolt, which, in turn, serves to attach the bowl to a perch, branch, or cage bar. A method for feeding an animal is also provided.

### FIELD OF THE INVENTION

The present invention relates to feeding apparatuses for birds and other animals.

### BACKGROUND OF THE INVENTION

In the present state of the art, various types of feeders are utilized for providing birds and other animals with food and water. Many of the known feeders are adapted to be attached to cage walls or to perch devices, thus allowing a bird to ingest food and water while situated within its cage or on an external perch. Typical feeding cups are made of stainless steel or other metals and are provided with a lead-free finish. Various plastics are also commonly used to construct feeders. Metal feeding cups can be more expensive than plastic ones and can be dangerous to the health of pet birds if they are not properly coated. On the other hand, conventional plastic cups can often be progressively destroyed through the pecking action of larger pet birds, such as parrots.

Feeding cups are often attached to cage walls or to perches through the use of bolts that are threadably engaged to the cups. While it is desirable that feeding cups be securely attached to cages or perches, the cups must be easily removable for refilling and cleaning. Larger birds may possess considerable strength and dexterity and, thus, may be able to unscrew a feeding cup that is not securely attached to a cage or perch. This may result in unnecessary spillage of food and can deprive a bird of necessary nutrients if the food spills beyond the bird's reach.

### BRIEF DESCRIPTION OF THE DRAWINGS

FIGS. 1a-b illustrate a feeding apparatus in accordance with an embodiment of the present invention. FIG. 1a is a side perspective view thereof. FIG. 1b is a side perspective view of the feeding apparatus attached to a branch or perch.

FIGS. 2a-b illustrate a locking mechanism in accordance with an embodiment of the present invention. FIG. 2a is a side perspective view thereof. A locking bolt that is internal to the locking mechanism is shown. FIG. 2b is a perspective view of the locking mechanism from above. The locking bolt is shown extending into the opening formed by the contour of the locking mechanism.

FIGS. 3a-b illustrate the operation of the locking mechanism. FIG. 3a is a side perspective view of the locking mechanism engaged to an attachment bolt that extends from a bowl structure of the feeding apparatus. The locking bolt that is internal to the locking mechanism is also shown. FIG. 3b is a side perspective view of an allen key engaged with the locking bolt of the locking mechanism.

FIG. 4 illustrates a perspective view of the bowl structure from above.

FIG. 5 illustrates a perspective view of the bowl structure from below. A connecting structure extending from the center of the base of the bowl structure is shown.

FIG. 6 illustrates the attachment bolt that may be threadably engaged with the connecting structure. A side perspective view thereof is shown.

### DETAILED DESCRIPTION

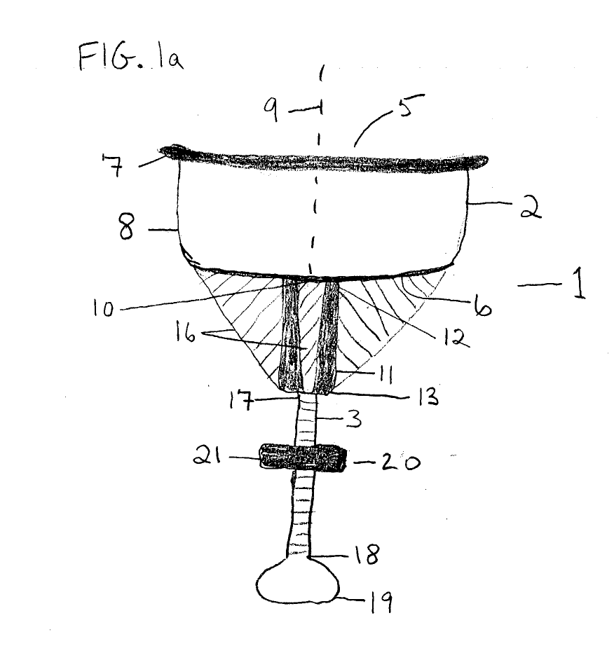

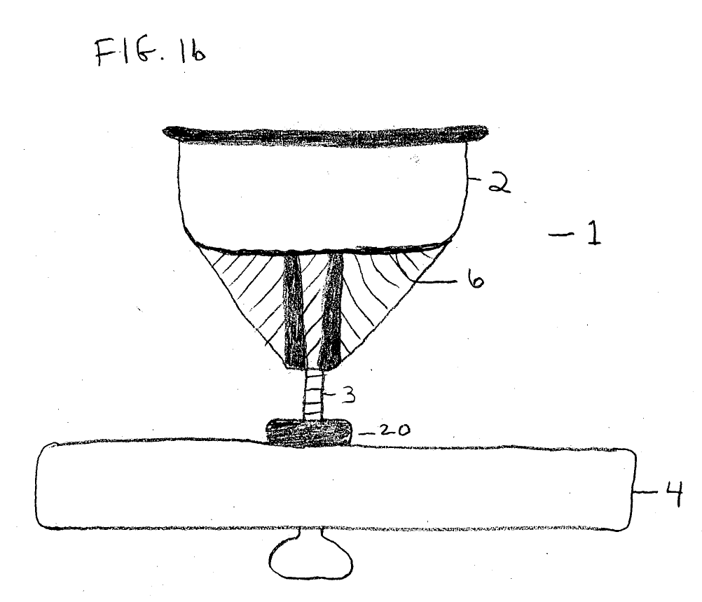

As shown in the drawings for purposes of illustration, one aspect of the invention is embodied in a bird feeding apparatus 1. As depicted in FIG. 1a, the bird feeding apparatus 1 may include a bowl 2 that is threadably engaged to an attachment bolt 3 at the center of a base 6 of the bowl 2. The bowl 2 may be constructed of any suitable material, such as, but in no way limited to, polycarbonate plastic. It will be readily apparent to one skilled in the art that many materials (in addition to polycarbonate plastic) may be employed in the construction of the bowl 2, as long as the materials are of sufficient strength and are not toxic to animals. As depicted in FIG. 1b, the bird feeding apparatus 1 may be attached to a perch 4 with the attachment bolt 3. The provided apparatus 1 may be resistant to certain detrimental actions of large pet birds, which may include the destruction of the bowl 2 (e.g., if it is not made of sufficiently resilient material) and the dislodging of the apparatus 1 from the perch 4 (e.g., if it is not sufficiently attached to the perch 4).

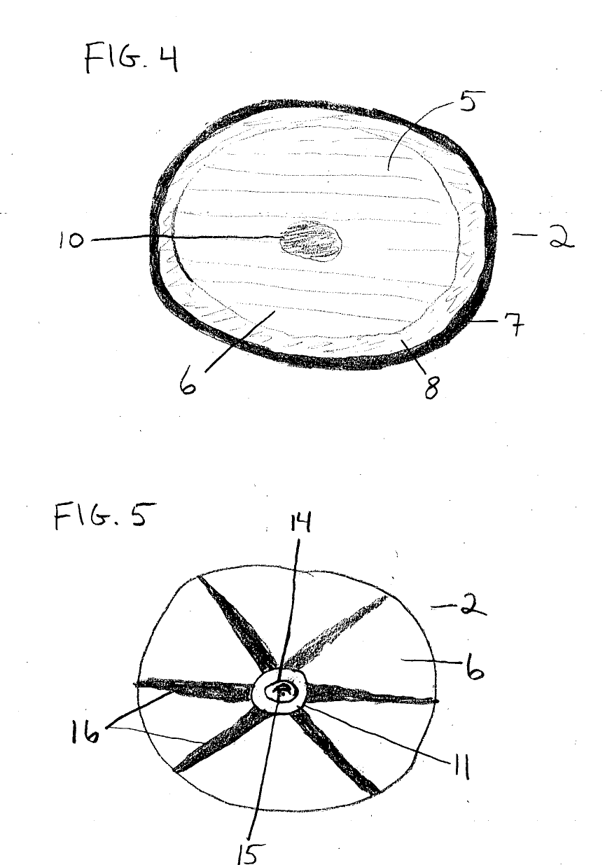

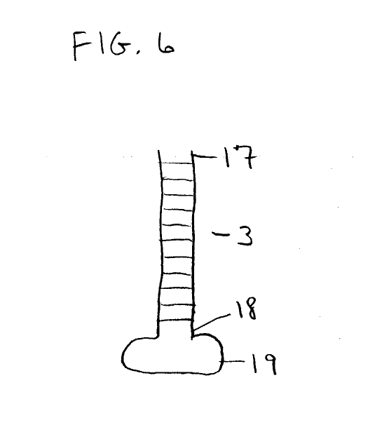

As depicted in FIG. 1a, the bowl 2 of the bird feeding apparatus 1 may be configured to have an open end 5 and may be further configured to have a closed end forming the base 6 (FIGS. 4 and 5 depict perspective views of the open end 5 and base 6 of the bowl 2, respectively). Additionally, the open end 5 of the bowl 2 may be contoured to form a lip 7. The sides 8 of the bowl 2 may be formed such that the shape of the bowl 2 is roughly cylindrical about a central axis 9. One skilled in the art will realize that the shape of the bowl 2 may vary, forming at its open end 5 a circle, a square, a rectangle, a triangle or any other shape. The base 6 of the bowl 2 may be roughly concave in contour, with a vertex 10 at the center of the base 6, positioned along the central axis 9 of the bowl 2. One skilled in the art will realize that the base 6 of the bowl 2 may be flat or convex or may have any other contour.

The apparatus 1 may be further configured to include a connecting structure 11 extending outwardly from the center of the base 6 of the bowl 2, the connecting structure 11 having proximal 12 and distal 13 ends (relative to the base 6 of the bowl 2). The connecting structure 11 may be cylindrical in shape, although one skilled in the art will realize that the connecting structure 11 may be square, rectangular, triangular or any other shape. The connecting structure 11 may be positioned along the central axis 9 of the bowl 2 and may have a circumference that is smaller than the circumference of the bowl 2. Additionally, the connecting structure 11 may include a female receiving portion 14 beginning at its distal end 13. As depicted in FIG. 5, the female receiving portion 14 may include an internally threaded metal fitting 15 that may be attached to the female receiving portion 14. The internally threaded metal fitting 15 may be configured to receive the attachment bolt 3. In alternative embodiments, the female receiving portion 14 itself may be internally threaded and, thus, may be configured to receive the attachment bolt 3. However, use of the internally threaded metal fitting 15 may produce a structure that is more resistant to wear. One skilled in the art will realize that the connecting structure 11 may extend outwardly from any position on the outside of the bowl 2; it need not be positioned at the center of the base 6 of the bowl 2 or along the central axis 9 of the bowl 2.

The apparatus 1 may further include support flanges 16 that may be equally spaced around the base 6 of the bowl 2. The support flanges 16 may form roughly triangular sections that may extend between the base 6 of the bowl 2 and the connecting structure 11. The support flanges 16 may thus confer a roughly conical appearance to the region of the apparatus 1 bounded by the base 6 of the bowl 2 and the distal end 13 of the connecting structure 11. The support flanges 16 may provide structural support to the bowl 2. Alternative embodiments of the present invention that do not include the connecting structure 11 and support flanges 16 are possible. For example, a bolt similar to the attachment bolt 3 of the present embodiment may directly engage the base 6 of the bowl 2.

As depicted in FIGS. 1a-b and 6, the feeding apparatus 1 may include an attachment bolt 3. The attachment bolt 3 may have a proximal end 17 (i.e., proximal to the bowl 2) and a distal end 18. Additionally, the attachment bolt 3 may include a knob 19 at its distal end 18, so as to provide for ease of manual operation of the attachment bolt 3. The proximal end 17 of the attachment bolt 3 may be adapted to engage the female receiving portion 14 of the connecting structure 11. Alternatively, the attachment bolt 3 may incorporate a handle at the distal end 18, or any other structure designed to ease the manual operation of the attachment bolt 3. The attachment bolt 3 may also be operated without the addition of any particular structure at its distal end 18.

As depicted in FIGS. 1a-b, 2a-b and 3a-b, the feeding apparatus 1 may further include a locking mechanism 20 that maintains the position of the bowl 2, the perch 4 and the attachment bolt 3 relative to one another; thereby preventing the apparatus 1 from being dislodged by a bird or other animal. The locking mechanism 20 may include a retaining structure 21 with an opening 22, the retaining structure 21 being adapted to engage the attachment bolt 3. The locking mechanism 20 may also include a locking bolt 23 that is threadably engaged through a side of the retaining structure 21; the locking bolt 23 making contact with the attachment bolt 3 to maintain the position of the locking mechanism 20 relative to the bowl 2. The locking bolt 23 may be configured to be operated with an allen key 24. The retaining structure 21 may be cylindrical in shape. However, one skilled in the art will realize that the retaining structure 21 may be configured in other shapes, such as, but in no way limited to, a square, a rectangle or a triangle. As depicted in FIG. 1b, positioning the locking mechanism 20 above the perch 4 and the knob 19 of the attachment bolt 3 below the perch 4 may prevent the knob 19 of the attachment bolt 3 from being turned, thus preventing the feeding apparatus 1 from being dislodged from the perch 4.

The above embodiment of the invention is provided by way of example. One skilled in the art will realize that several alternate embodiments of the bird feeding apparatus are possible. It will be readily apparent that such alternate embodiments may be used as feeding apparatuses for pet birds of any size, for animals other than birds and for birds or other animals that are not domesticated.

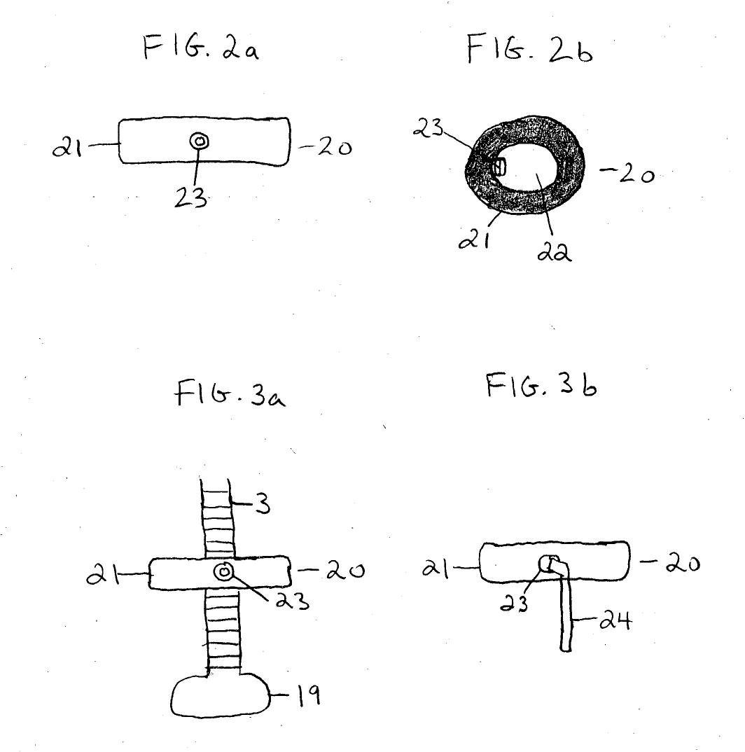

In another embodiment of the present invention, a method is provided for feeding birds. The method may include attaching a bird feeding apparatus 1 to a perch 4 by inserting an attachment bolt 3 upwards through a hole in the perch 4, placing a locking mechanism 20 on the attachment bolt 3 above the perch 4, tightening a locking bolt 23 of the locking mechanism 20 with an allen key 24 and engaging a bowl 2 to the attachment bolt 3 (e.g., as depicted in FIGS. 1b, 3a and 3b). The method may further include placing food or water in the bowl 2 and exposing an animal to the apparatus 1 to feed the animal.

As depicted in FIG. 1a, the bird feeding apparatus 1 may include a bowl 2 that is threadably engaged to an attachment bolt 3 at the center of a base 6 of the bowl 2. The bowl 2 may be constructed of any suitable material, such as, but in no way limited to, polycarbonate plastic. The present method may prevent certain detrimental actions of large pet birds, which may include the destruction of the bowl 2 (e.g., if it is not made of sufficiently resilient material) and the dislodging of the apparatus 1 from the perch 4 (e.g., if it is not sufficiently attached to the perch 4).

As depicted in FIG. 1a, the bowl 2 of the bird feeding apparatus 1 may be configured to have an open end 5 and may be further configured to have a closed end forming the base 6 (FIGS. 4 and 5 depict perspective views of the open end 5 and base 6 of the bowl 2, respectively). The sides 8 of the bowl 2 may be formed such that the shape of the bowl 2 is roughly cylindrical about a central axis 9. The base 6 of the bowl 2 may be roughly concave in contour, with a vertex 10 at the center of the base 6, positioned along the central axis 9 of the bowl 2.

The apparatus 1 may be further configured to include a connecting structure 11 extending outwardly from the center of the base 6 of the bowl 2, the connecting structure 11 having proximal 12 and distal 13 ends (relative to the base 6 of the bowl 2). The connecting structure 11 may be cylindrical in shape. The connecting structure 11 may be positioned along the central axis 9 of the bowl 2 and may have a circumference that is smaller than the circumference of the bowl 2. Additionally, the connecting structure 11 may include a female receiving portion 14 beginning at its distal end 13. As depicted in FIG. 5, the female receiving portion 14 may include an internally threaded metal fitting 15 that may be attached to the female receiving portion 14. The internally threaded metal fitting 15 may be configured to receive the attachment bolt 3.

The apparatus 1 may further include support flanges 16 that may be equally spaced around the base 6 of the bowl 2. The support flanges 16 may form roughly triangular sections that may extend between the base 6 of the bowl 2 and the connecting structure 11. The support flanges 16 may provide structural support to the bowl 2.

As depicted in FIGS. 1a-b and 6, the feeding apparatus 1 may include an attachment bolt 3. The attachment bolt 3 may have a proximal end 17 (i.e., proximal to the bowl 2) and a distal end 18. Additionally, the attachment bolt 3 may include a knob 19 at its distal end 18, so as to provide for ease of manual operation of the attachment bolt 3. The proximal end 17 of the attachment bolt 3 may be adapted to engage the female receiving portion 14 of the connecting structure 11.

As depicted in FIGS. 1a-b, 2a-b and 3a-b, the feeding apparatus 1 may further include a locking mechanism 20 that maintains the position of the bowl 2, the perch 4 and the attachment bolt 3 relative to one another; thereby preventing the apparatus 1 from being dislodged by a bird. The locking mechanism 20 may include a retaining structure 21 with an opening 22, the retaining structure 21 being adapted to engage the attachment bolt 3. The locking mechanism 20 may also include a locking bolt 23 that is threadably engaged through a side of the retaining structure 21; the locking bolt 23 making contact with the attachment bolt 3 to maintain the position of the locking mechanism 20 relative to the bowl 2. The locking bolt 23 may be configured to be operated with an alien key 24. The retaining structure may be cylindrical in shape. As depicted in FIG. 1b, positioning the locking mechanism 20 above the perch 4 and the knob 19 of the attachment bolt 3 below the perch 4 may prevent the knob 19 of the attachment bolt 3 from being turned, thus preventing the feeding apparatus 1 from being dislodged from the perch 4.

The apparatus 1 of the present method is described by way of example. Alternative embodiments of the apparatus are possible, such as, but in no way limited to, those already described herein. All alternative embodiments are suitable for purposes of the present method.

The apparatus 1 of the present method may be attached to a branch or perch that is situated inside or outside a cage or other containment structure, and may also be attached to an element of the cage or containment structure. One skilled in the art will realize that the branch or perch that the apparatus 1 is attached to may be made of any material and may be a component of a larger bird feeding or exercise station, or indeed, a component of a bird cage. The method of the present embodiment may provide a means for feeding birds whereby the birds cannot destroy or dislodge the feeding apparatus 1. It will be readily apparent to one skilled in the art that the method of the present embodiment may be used to feed pet birds of any size, animals other than birds and birds or other animals that are not domesticated.

While the description above refers to particular embodiments of the present invention, it should be readily apparent to people of ordinary skill in the art that a number of modifications may be made without departing from the spirit thereof. The accompanying claims are intended to encompass such modifications as would fall within the true spirit and scope of the invention. The presently disclosed embodiments are, therefore, to be considered in all respects as illustrative and not restrictive. Accordingly, the scope of the invention is indicated by the appended claims rather than the foregoing description. All changes that come within the meaning and range of equivalency of the claims are intended to be embraced therein.

What is claimed is:

1. A feeding apparatus comprising:
a bowl with an open end and a closed end, the closed end forming a base;
a connecting structure extending outwardly from the bowl, the connecting structure having proximal and distal ends, the connecting structure including a female receiving portion;
an attachment bolt to engage the female receiving portion, the attachment bolt including a proximal end and a distal end; and
a locking mechanism to engage the attachment bolt.

2. The feeding apparatus of claim 1, wherein the bowl is constructed from polycarbonate plastic.

3. The feeding apparatus of claim 1, wherein the open end of the bowl is contoured to form a lip.

4. The feeding apparatus of claim 1, wherein the shape of the bowl is roughly cylindrical about a central axis.

5. The feeding apparatus of claim 4, wherein the connecting structure is positioned along the central axis.

6. The feeding apparatus of claim 1, wherein the shape of the bowl at its open end is selected from the group consisting of a circle, a square, a rectangle and a triangle.

7. The feeding apparatus of claim 4, wherein the base of the bowl has a concave contour, with a vertex positioned along the central axis.

8. The feeding apparatus of claim 1, further including an internally threaded metal fitting attached to the female receiving portion.

9. The feeding apparatus of claim 1, wherein the apparatus includes at least one support flange, the at least one support flange extending between the base of the bowl and the connecting structure.

10. The feeding apparatus of claim 1, wherein the attachment bolt includes a knob or a handle.

11. The feeding apparatus of claim 1, wherein the locking mechanism includes:
a retaining structure with an opening, the retaining structure being adapted to engage the attachment bolt; and
a locking bolt that is threadably engaged through a side of the retaining structure.

12. The feeding apparatus of claim 11, wherein the retaining structure is cylindrical in shape.

13. The feeding apparatus of claim 11, wherein the locking bolt is adapted to be operated with an allen key.

14. A method of attaching a feeding apparatus comprising:
inserting an attachment bolt through a hole in a perch;
placing a locking mechanism including a locking bolt on the attachment bolt on the opposite side of the perch;
tightening the locking bolt of the locking mechanism; and
engaging a bowl to the attachment bolt.

15. The method of claim 14, wherein tightening the locking bolt further includes tightening the locking bolt with an allen key.

16. The method of claim 14, wherein the feeding apparatus comprises:
a bowl; and
a connecting structure extending outwardly from the bowl, the connecting structure including a female receiving portion.

17. The method of claim 14, wherein the feeding apparatus comprises:
an attachment bolt; and
a locking mechanism.

18. The method of claim 14, wherein the perch is selected from the group consisting of a branch, an element of a cage and an element of a containment structure.

19. A method of feeding an animal comprising:
inserting an attachment bolt through a hole in a perch;
placing a locking mechanism including a locking bolt on the attachment bolt on the opposite side of the perch;
tightening the locking bolt of the locking mechanism;
engaging a bowl to the attachment bolt;
placing food or water in the bowl; and
exposing an animal to the bowl.

20. The method of claim 19, wherein tightening the locking bolt further includes tightening the locking bolt with an allen key.

21. The method of claim 19, wherein the animal is a bird.
